(19) United States
(12) Patent Application Publication
(10) Pub. No.: US 2018/0320481 A1
(43) Pub. Date: Nov. 8, 2018

(54) SOLUTION TO AIR POLLUTION

(71) Applicant: Stephen Bruce Richards, HOUSTON, TX (US)

(72) Inventor: Stephen Bruce Richards, HOUSTON, TX (US)

(21) Appl. No.: 15/589,559

(22) Filed: May 8, 2017

(51) Int. Cl. E21B 41/00; E21B 43/16; C04B 2/08; C04B 2/10; C01F 11/18; B01D 53/62; B01D 53/82; B01D 53/96

(52) U.S. Cl. CPC E21B 41/0064; E21B 43/164; C04B 2/08; C04B 2/10; C01F 11/181; B01D 53/62; B01D 2258/02; B01D 53/96; B01D 2251/404; B01D 2251/602; B01D 2251/604; B01D 2257/504; B01D 2253/1124; B01D 53/82

(57) ABSTRACT

Air pollution includes emissions from two sources: fixed sources and moving sources. A fixed source could be an electric power generation facility or a lime kiln. A moving source can be a tail pipe such as one on an automobile. The fixed source's emissions are redirected downward into a depleted hydrocarbon reserve through an injection well. The moving source is attached to a Carbonator which takes calcium oxide from the lime kiln and carbon dioxide from the moving source to produce calcium carbonate. This removes two sources of air pollution, first the use of the Carbonator system to remove Carbon Dioxide Emissions into the Atmosphere as described in the Application and secondly the total injection of all smokestack effluents into depleted reservoirs, removing the smokestack and in an electrical generating station HVDC transmission lines are run to the displaced smokestack, and is thus a solution to air pollution.

### BACKGROUND

Air pollution is a complicated problem that requires a comprehensive solution. This application solves the problem of undesirable composition of emissions into the Atmosphere. When it is deemed by the emitter, that the cessation of all emissions from a smoke stack or tailpipe is impractical, another option is claimed which removes only the carbon dioxide from the emitter's emissions, and not allow for the CO2 to enter the Atmosphere. There are many sources of CO2 emissions, however, embodiments herein relate generally to systems that remove all emissions from entering into the Atmosphere, but in the alternative, only just the carbon dioxide may be removed from smoke stacks and tail pipes prior to discharge into the Atmosphere.

There are additional strategies for reducing or eliminating air pollution claimed in this application, such as using high voltage direct current lines (HVDC) and also such things as depleted hydrocarbon reservoirs which are part of this invention.

Prior to embodiments of the disclosed invention, smoke stacks and tail pipes released carbon emissions into the atmosphere. Embodiments of the disclosed invention solve this problem of undesirable carbon emissions.

### SUMMARY

Air pollution is a problem that has to do with emissions from two sources: fixed sources and moving sources. A fixed source could be an electric power generation facility or a lime kiln. The lime kiln can be attached to a calcium carbonate source, an air source and a fuel source such as Bengal coal or natural gas. The lime kiln produces a carbon dioxide discharge, a calcium (or alkali metal) oxide discharge, which is the feedstock for this Patent Application's use of its “Carbonator” system that eliminates CO2 emissions from being discharged into the Atmosphere, and finally a water discharge. A moving source can be a tail pipe such as the one on an automobile.

The fixed source's emissions from the lime kiln are redirected downward into a depleted hydrocarbon reservoir(s) through an injection well(s). The resulting calcium oxide is slacked with water and the resulting lime is used as the feed stock for the Carbonator, which is a reaction chamber in which gaseous carbon dioxide is converted into a carbonate solid such as calcium carbonate as disclosed. As used in this application “lime” means one member of the set consisting of: calcium oxide, calcium hydroxide, and both calcium oxide and calcium hydroxide.

The moving source emitter and also a fixed source emitter, is attached to a Carbonator as described and included in this application, which takes lime from a lime kiln, as described above, which never allows the CO2 byproduct from the creation of lime, to be discharged into the Atmosphere. This removes carbon dioxide from tailpipes and smokestacks by not discharging it into the Atmosphere by using the lime to react to form a carbonate, thereby trapping the CO2, for a second time. The system is thus a viable solution to carbon dioxide emissions from either tailpipes or smoke stacks.

Unlike the current art, the CO2 is chemically as well as mechanically trapped. Firstly by total injection of the lime kiln's effluents mechanically and/or injecting carbon dioxide which is the by-product of calcium oxide creation into depleted reservoirs, and secondly by taking that lime kiln's product of lime and chemically trapping the CO2 from tailpipe's or smoke stack's discharge using the Carbonator as described previously, into the Atmosphere. The CO2 discharge is chemically trapped in the Carbonator's reaction chamber making a solid out of it using the lime product from the lime kiln that has an injection well instead of a smoke stack and mechanically injects the carbon dioxide by-product.

A sequestering system can also be used for preventing carbon dioxide from being released into ambient air. The sequestering system has an injection well, located over a depleted hydrocarbon reservoir(s) further comprising a void. The fixed emission source is attached to a pipeline. The pipeline pumps emissions from the fixed emission source into the injection well. The injection well pumps the emissions into the void. A lime kiln can be attached to a calcium carbonate source, an air source and a natural gas source. The lime kiln produces a carbon dioxide discharge, a calcium oxide discharge and a water discharge. The carbon dioxide discharge produced by the lime kiln, is always contained and never allowed to be discharged into the Atmosphere. Injection of the carbon dioxide into depleted hydrocarbon reservoirs is an option to never discharge the byproduct CO2 from the lime kiln, and thus, the creation of the calcium oxide/calcium hydroxide, which is the feedstock for the Carbonator.

The lime kiln uses the carbonate equation endothermically one way as shown below, and the Carbonator uses the same equation in the reverse direction exothermically. However, unlike the prior art, the CO2 by product from the lime kiln is not released into the Atmosphere. This can be represented by: CaCO3=CaO+CO2

The Carbonator carbon removal system can be configured to combine calcium oxide, derived from the fixed source kiln, that created the calcium oxide or calcium hydroxide feed stock and injected all of the CO2 from heating the limestone, from the kiln into depleted hydrocarbon reservoirs. The Carbonator's reaction chamber, is configured to receive the calcium oxide or calcium hydroxide with the trapped CO2 by product when it was created by heating the CaCO3. The feedstock enters the Carbonator through a lime input shoot. A paddle wheel can be inside the lime input shoot connected to an electric motor. An acidity sensor can be attached to the reaction chamber and communicatively coupled to the electric motor. The acidity sensor is adapted to control the lime released through the lime input shoot into the reaction chamber.

The feedstock for the Carbonator varies depending on the amount of CO2 needed to trap. A large discharging smoke stack can use the calcium oxide rather than the calcium hydroxide feedstock since its more unstable state will attract more CO2 but in doing so it will release much more heat than the calcium hydroxide feedstock, so that the reaction chamber for this application of the Carbonator for large smoke stacks must accommodate a large amount of pressure and high temperatures in order to convert the abundant discharge of the smoke stack's CO2 by a more reactive exothermic chemical reaction, using heat exchangers.

The feedstock for a Carbonator applied to the tailpipe of an automobile will generally use (in addition to calcium oxide in various cases or other alkali metal oxides) calcium hydroxide due to its reaction with CO2 which is not as reactive as the pure calcium oxide and does not produce the same quantity or magnitude of exothermic heat than the calcium oxide.

The amount of heat produced, compared to the application of the Carbonator for autos which uses the calcium hydroxide less reactive CO2 capture requirements with less heat and pressure in the reaction chamber, the lime kiln must produce both calcium hydroxide as well as calcium oxide. When the calcium hydroxide is created at the lime kiln without a smoke stack due to depleted hydrocarbon reservoir injection, the heat from slacking the calcium oxide into calcium hydroxide made at a reaction chamber at the lime kiln site, has heat exchangers.

A pressurized storage container can be connected to the reaction chamber. A tail pipe or smokestack emission source can be connected to the pressurized storage container with an air pump. Emissions can be pumped from the tail pipe or smokestack emission source into the pressurized storage container and are then released into the reaction chamber of the Carbonator.

This patent traps the CO2 twice, first by injecting the lime kiln's effluents into the depleted reservoirs, then the CO2 is further trapped in a separate different way, by taking the lime discharge from the lime kiln and using it as the feedstock for the Carbonator's ability to turn the gaseous exhaust CO2 into a solid by using the smoke stackless lime kiln's lime.

A gas recycling tube can be connected to the reaction chamber and an automatic valve configured to permit and restrict access to the gas recycling tube connected to the pressurized storage container. A settlement chamber can surround the reaction chamber where a calcium carbonate slurry settles and rakes and drains into a calcium carbonate slurry tank. A water pipe can be attached to the calcium carbonate slurry tank and configured to direct water through the calcium carbonate slurry tank driving the calcium carbonate slurry into a calcium carbonate slurry output pipe. A water holding tank can be connected to the water pipe. The water holding tank can be further connected to the settlement chamber with a water discharge tube. A flow of water in and out of the water holding tank can affect the amount of water in the reaction chamber as well as the settlement chamber.

A fixed source electric power plant can be positioned upon depleted hydrocarbon reservoirs and all effluents from the coal, gas or oil fired power plant are injected into the depleted hydrocarbon reservoirs. High voltage direct current (HVDC) transmission lines are run from the new power plant, with no smokestack, to the smokestack of the power plant it will displace, this stops all air pollution from the fixed source's smokestack and utilizes current art HVDC technology using advanced thyristors. As used in this application a thyristor is “A thyristor is a solid-state semiconductor device with four layers of alternating N and P-type materials. It acts exclusively as a bistable switch, conducting when the gate receives a current trigger, and continuing to conduct while the voltage across the device.”

These rectifier/inverter gate stations placed across the various power pools will balance the pools against each other as the HVDC transmission line reaches the smokestack it is to displace. As an example, large scale power plants are placed over depleted reservoirs of the Anadarko basin, will have a long useful life due to the enormity of the underground depleted reservoir void space. The Anadarko's close proximity to existing smokestacks to displace, and the many power pools the HVDC line crosses, can be used to balance these pools using different voltages and frequencies.

The United States' BLM and the state oil and gas Land Commission's leases do not currently have provisions in them yet, which will allow for conservation and for the prevention of the wells to be become abandoned, as well as, the gathering lines, and production equipment, which are currently costing billions of dollars in the waste of depleted hydrocarbon reservoir/air pollution assets, due to their continued permission of abandonment.

Currently, gaseous waste is being discharged into the Atmospheric/Oceanic sewer system and not using the enormous void space created by the depleting of hydrocarbon reservoirs for the last 150 years. The solution for this involves depleted hydrocarbon reservoirs, and the injection of the CO2 into these depleted hydrocarbon reservoirs and not into the current art's Atmospheric/Oceanic sewer system.

The current or prior art, involves the placement of lime kilns, which are currently being chosen because of the high calcium quality of the limestone, and the proximity of the location to shipping by ships, or other shipping options.

This new art will cause the placement of future kilns, with the new kilns being placed over depleted hydrocarbon reservoirs as the primary reason for placement of the location, in addition to the calcium quality of the limestone and its location to various shipping options. Such kilns will provide lime feedstock for the Carbonator.

The car owner that displaces his hydrocarbon internal combustion engine with an electric motor is still polluting indirectly through the power plant's current art's smokestack.

Configuration of the HVDC transmission lines will consider where the depleted hydrocarbon reservoirs are, relative to where the current electric generating smokestacks are, relative to each other's respective geographical footprints.

When considered individually and considered as a whole together, the current smokestacks, relative to the position of the depleted hydrocarbon reservoirs predicate the optimum position of the future HVDC system that is to be configured in such a way as to also balance out the existing power pools, which are selected and the position of such future gate stations in the inverter/rectifier HVDC transmission system.

This therefore predicates as an example of this application using the United States, an oblong looped HVDC transmission system that can disconnect and reconnect itself at each other's opposing end terminuses of the oblong loop. The northern and southern portions of the loop, has terminuses' in the Permian Basin and the other terminuses in the Boston area.

It would then be best to have a double looped HVDC transmission system, that crosses each power pool with semi-circular double oblong loops of the HVDC transmission lines and the outer most loop will cross and intersect each respective power pool with the terminuses of its most northerly part that can disconnect and rejoin with the HVDC transmission line onto itself. The most southern (bottom) portion of the outer most loop could utilize Transco/Colonial/Algonquin's rights of way on the Southern portion of the loop, while the Northern part of the loop could utilize Arkla's as well as Tennessee's rights of way.

The semicircular loops can connect and reconnect into four separate distinct lines into a myriad of different configurations.

### BRIEF DESCRIPTION OF THE FIGURES

The detailed description of some embodiments of the invention is made below with reference to the accompanying figures, wherein like numerals represent corresponding parts of the figures.

FIG. 1 shows a schematic view of one embodiment of the present invention.

FIG. 2 shows a schematic view of one embodiment of the present invention.

FIG. 3 shows a schematic view of one embodiment of the present invention.

FIG. 4 shows a schematic view of one embodiment of the present invention.

FIG. 5 shows a schematic view of one embodiment of the present invention.

FIG. 6 shows the Panhandle, Tenn. and Transco pipelines.

FIG. 7 shows the Panhandle, Tenn. and Transco pipelines.

### DETAILED DESCRIPTION OF CERTAIN EMBODIMENTS

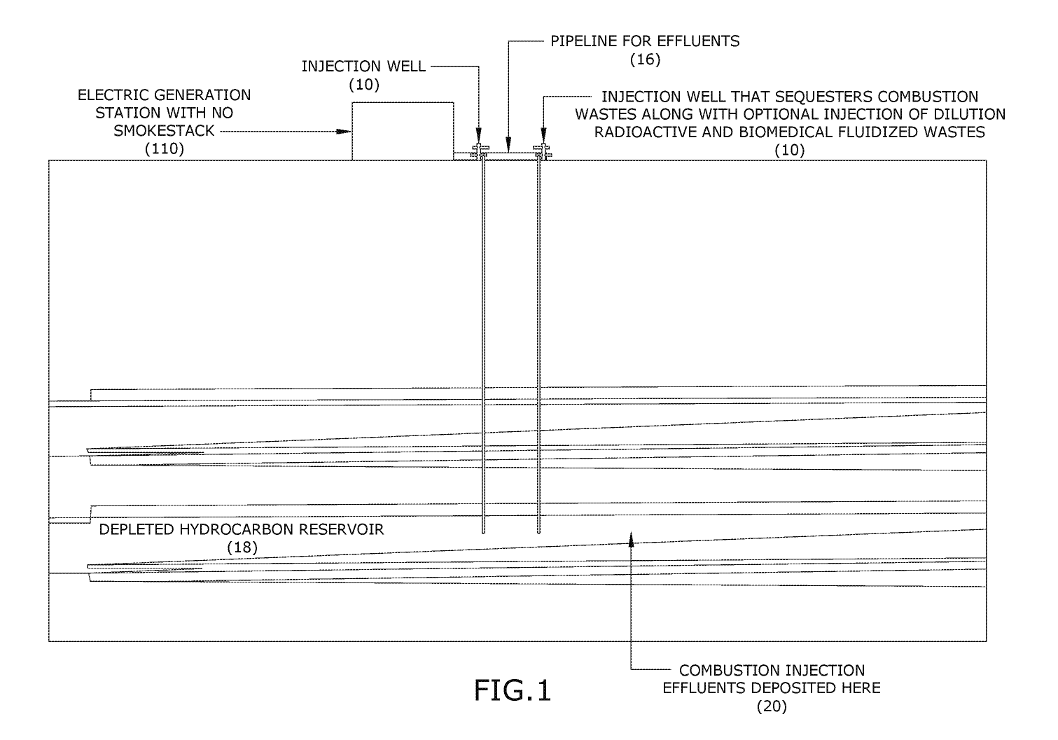

By way of example, and referring to FIG. 1, one embodiment of a sequestering system comprises injection well 10 which is configured to receive emissions from fixed emission source with no smoke stack 110 and pump those emissions into depleted hydrocarbon reserve 18. Alternately, the injection well 10 can be configured to receive sequestered combustion waste along with an optional injection of dilution radioactive and biomedical fluidized wastes. Either way, material is injected into depleted hydrocarbon reserve 18 filling void 20. In some cases injection well 10 is connected to pipeline 16 in order to obtain effluents that are not in the same location as the injection well.

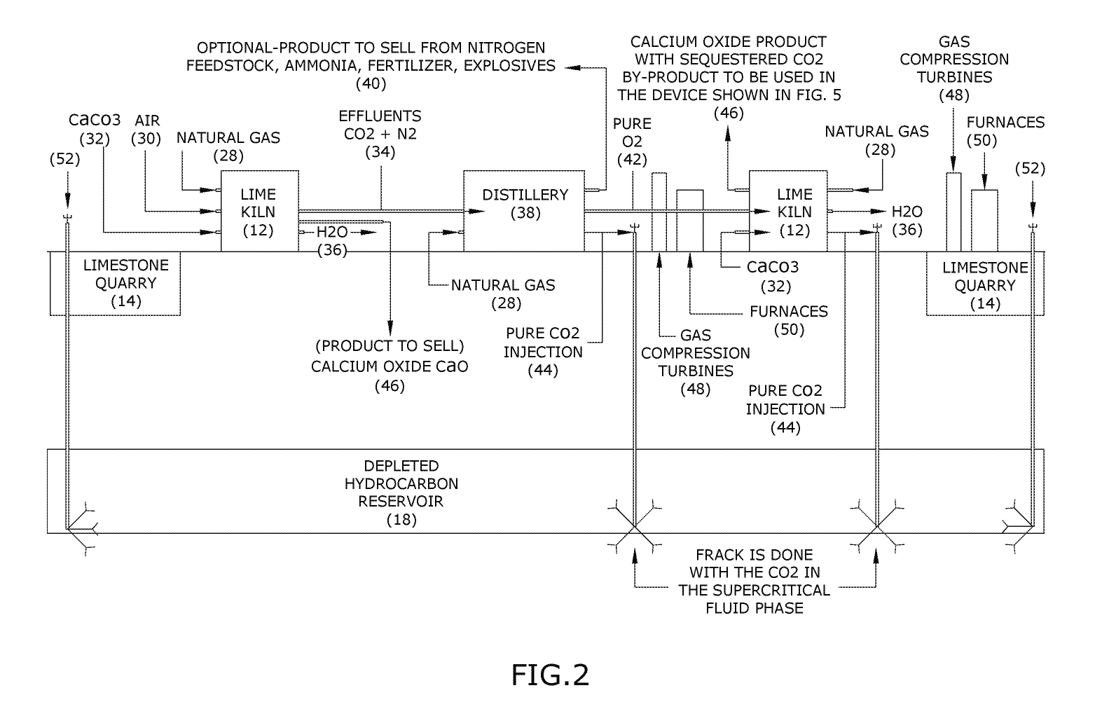

Turning to FIG. 2, limestone quarry 14 is connected to initial injection well 52. Limestone quarry 14 provides limestone 32 for lime kiln 12. Lime kiln 12 receives natural gas 28 through a natural gas source, air 30 through an air source and limestone 32 (calcium carbonate CaCO₃) through a calcium carbonate source. This compound is heated to produce effluents 34, including carbon dioxide CO₂ and nitrogen N₂ which are transferred into distillery 38. The heated compound further produces calcium oxide 46 (CaO) through a calcium oxide discharge, which is sequestered and is the sole feed stock for the Carbonator since it's CO₂ by-product has been trapped into depleted hydrocarbon reservoirs, any calcium oxide or hydroxide not made this way will emit CO2 into the Atmosphere. The heated compound further produces water (H₂O) through a water discharge.

Distillery 38 receives the effluents 34 and natural gas 28 to produce oxygen (O₂) 42 through an oxygen discharge and carbon dioxide 44 through a carbon dioxide discharge. In some embodiments, optional products 40 can additionally be sequestered such as nitrogen feedstock from a nitrogen feedstock discharge, ammonia, fertilizer and explosives. The second carbon dioxide discharge is converted to a supercritical fluid and then injected into depleted hydrocarbon reserve 18.

The oxygen 42 is pumped into a second lime kiln 12 along with limestone 32 and natural gas 28. In some embodiments the oxygen 42 can be used in compression turbines 48 and furnaces 50. Second lime kiln 12 produces calcium oxide 46 which includes calcium oxide with sequestered carbon dioxide. The process further produces water 46 and super critical carbon dioxide which is injected into the depleted hydrocarbon reserve 18.

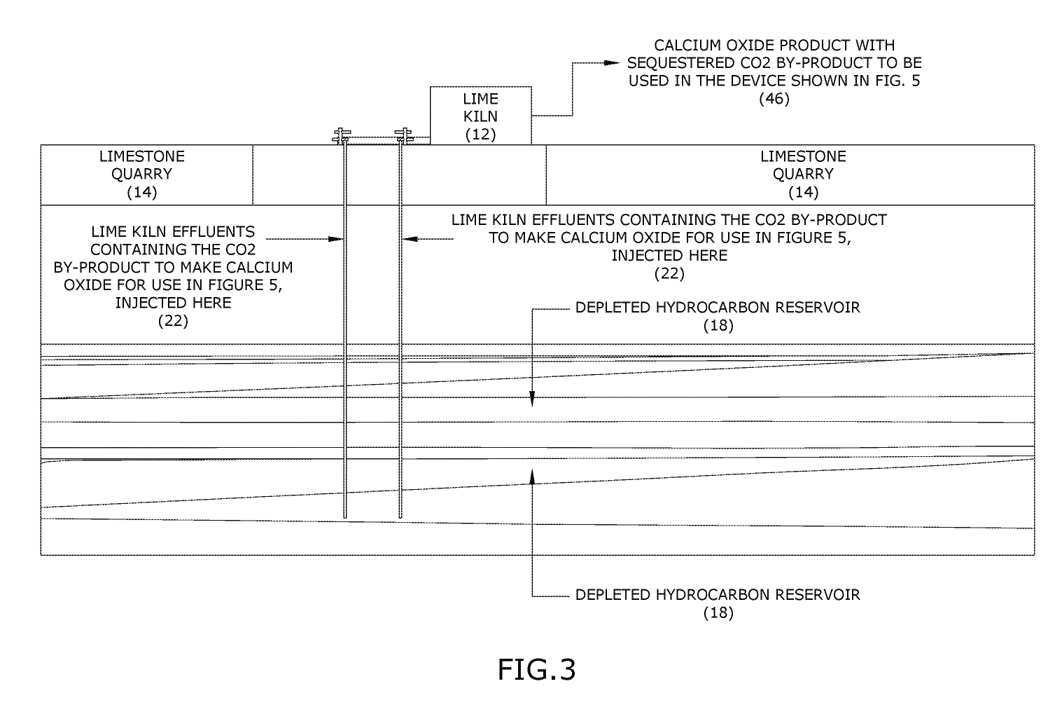

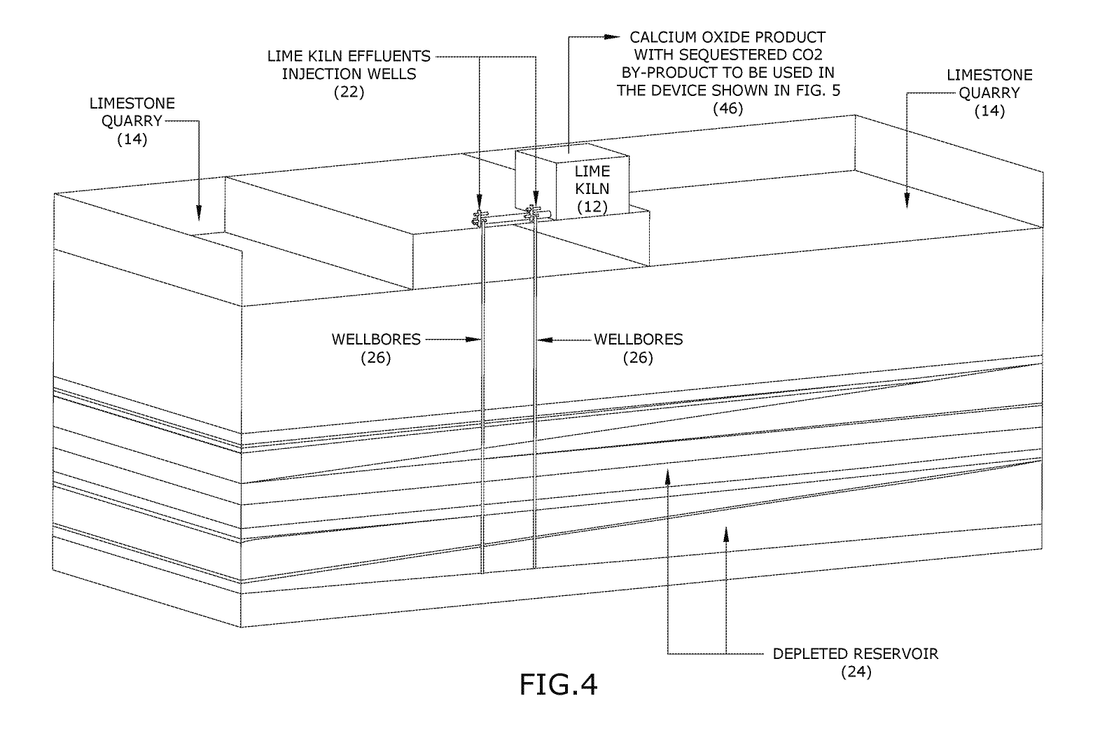

In a local formation, lime quarry 14 can be directly attached to gas compression turbines 48 and furnaces 50. As shown in FIG. 3 and FIG. 4, lime kiln 12 can produce calcium oxide 46 from heating limestone 32, natural gas 28 and air 30. The lime kiln effluents 22 are injected into depleted hydrocarbon reserve 18 using lime kiln effluent ejection wells 22 connected to wellbores 26.

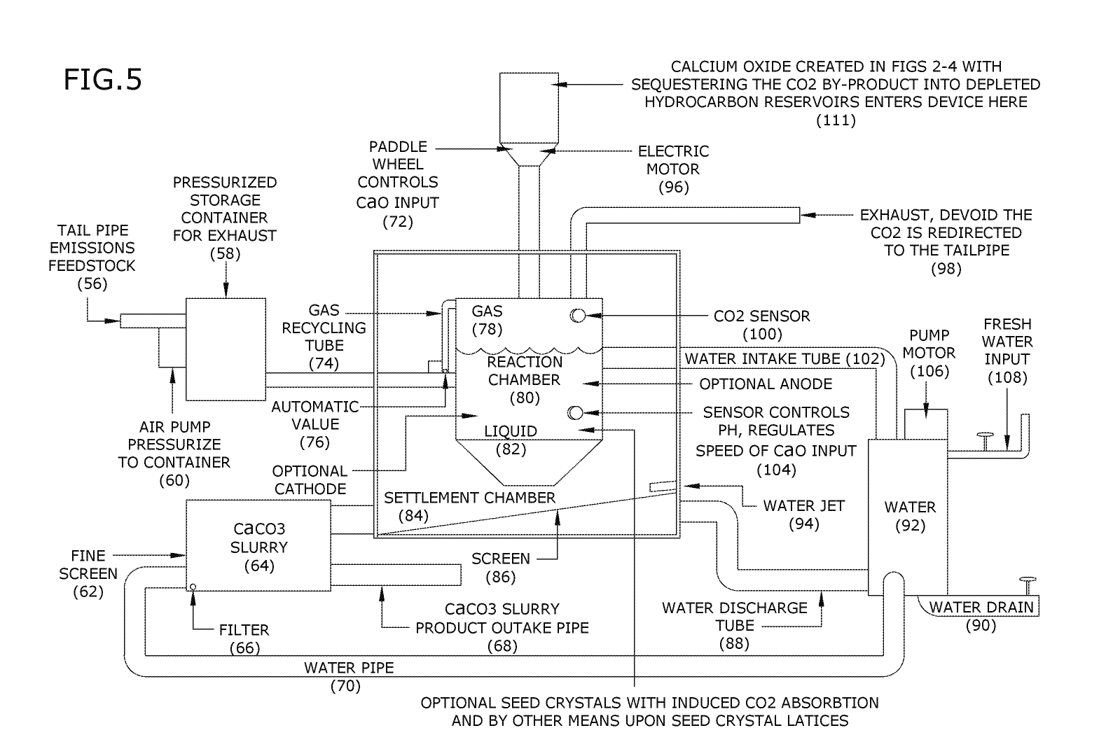

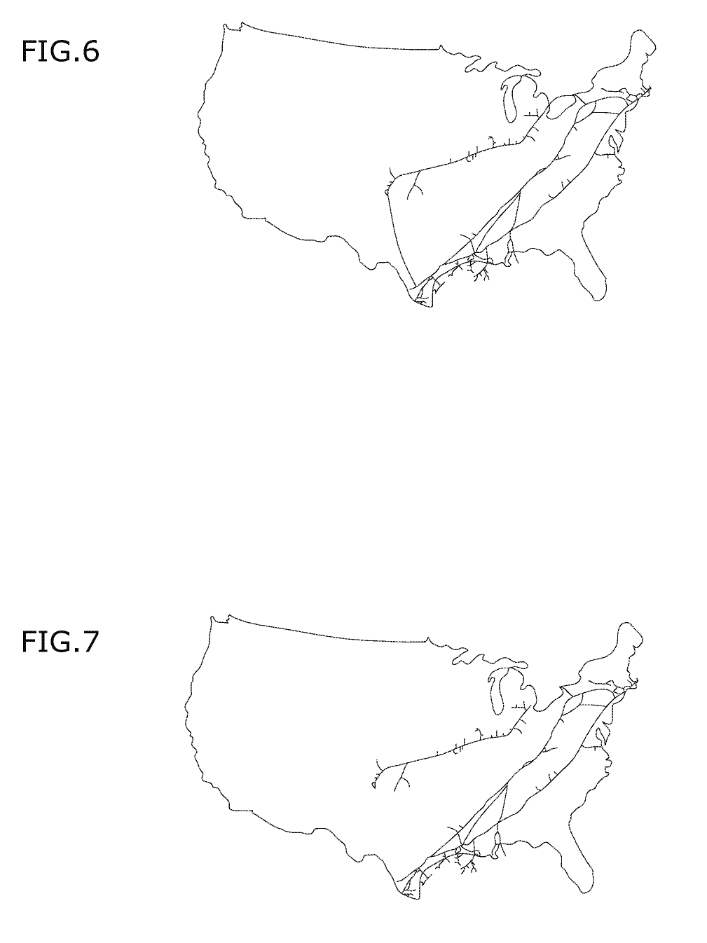

All of the calcium oxide 46 produced above is utilized in the Carbonator illustrated in FIG. 5. Calcium oxide 46 is inserted through calcium oxide input shoot 111. Calcium oxide input shoot 111 further comprises electric motor 96 connected to paddle wheel 72. Electric motor turns paddle wheel 72 to permit calcium oxide 46 to be gravity fed into reaction chamber 80. Reaction chamber 80 is installed in settlement chamber 84 which further comprises screen 86.

Reaction chamber 80 is connected to pressurized storage container 58. Pressurized storage container 58 is attached to tail pipe emission source 56 with air pump 60. Emissions from an emission source are pumped into pressurized storage container 58 which are then released into reaction chamber 80.

Reaction chamber 80 is partially filled with liquid 82 such as a level of water. In some cases, liquid 82 can further comprise seed crystals with induced CO₂ absorption and by other means upon seed crystal lattices. Reaction chamber 80 further comprises acidity sensor 104. Acidity sensor 104 is communicatively coupled to electric motor 96. Acidity sensor 104 allows more calcium oxide 46 into the reaction chamber depending on the acidity level of liquid 82 in reaction chamber 80.

When operating, reaction chamber 80 combines calcium oxide 46 with carbon dioxide to form calcium carbonate slurry 64, water 92, and exhaust 98. Exhaust 98 is redirected back to tail pipe emission source 56 depending on the level of carbon dioxide on carbon dioxide sensor 100 attached to reaction chamber 80.

Water 92 is removed from reaction chamber 80 through water intake tube 102 into a water holding tank through a flow of water. The level of the water holding tank can be adjusted with fresh water input 108 and water drain 90. Water can be inserted into settlement chamber 84 through water discharge tube 88 and water jet 94. The water holding tank is connected to calcium carbonate slurry tank 64 with water pipe 70. Water pipe 70 is connected to calcium carbonate slurry tank 64 with fine screen 62 and filter 66. Calcium carbonate slurry can be discharged through Calcium carbonate slurry output pipe 68, which can then be dried and inserted back into lime kiln 12 as discussed above. In some embodiments, it is useful to have gas 78 in reaction chamber 80 be adjusted by maneuvering automatic valve 76 which permits gas 78 to move through gas recycling tube 74.

This application is not limited to calcium oxide since other metal oxides which can be precipitated to form a solid carbonate when it connects with gaseous carbon dioxide and they are Sodium to form Baking Soda, Magnesium oxide to precipitate out to form dolomite, and not limited to Ferrous Oxide to form Iron carbonate or Iron Ore so not just limited to Calcium carbonate in the process, but all carbonates formed by exposing any metal oxide in an aqueous environment to form a hydroxide so when in contact with CO₂ will precipitate out to any type of carbonate.

In some embodiments, the void is a depleted reservoir of one of the set consisting of a Permian basin and an Anadarko basins. The at least one high voltage direct current transmission line can be located in one of the set consisting of a right of way of a Texas Eastern natural gas pipeline and a Tennessee natural gas pipelines. The at least one high voltage direct current transmission line can be further located in one of the set consisting of a Transco natural gas pipeline and a Colonial pipeline.

The sequestering system can utilize at least one rectifier/inverter thyristor gate station, connected to the at least one high voltage direct current transmission line. The at least one rectifier/inverter thyristor gate station is configured to balance frequency and voltage of electricity over various power pools. The power generating station can be a coal fired power generation station. The coal fired power generation station can receive coal from Tulsa at a terminus of a navigable waterway system.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, ¶6. In particular, any use of “step of” in the claims is not intended to invoke the provision of 35 U.S.C. § 112, ¶6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A sequestering system for preventing carbon dioxide from being released into ambient air; the sequestering system, comprising:
an injection well, located over a depleted hydrocarbon reservoir further comprising a void;
a fixed emission source, attached to a pipeline, wherein the pipeline pumps emissions from the fixed emission source into the injection well; wherein the injection well pumps the emissions into the void.

2. The sequestering system of claim 1, further comprising: a lime kiln, attached to a calcium carbonate source, an air source and a coal, oil or natural gas source; wherein the lime kiln produces a carbon dioxide discharge, a lime discharge and a water discharge, the carbon dioxide which is discharged is trapped by the injection into the void wherein the lime discharge becomes a sorbent, to further regain the CO2 to become calcium carbonate again.

3. The sequestering system of claim 2, further comprising:
a distillery, attached to the carbon dioxide discharge and the natural gas source; wherein the distillery produces a second carbon dioxide discharge, a nitrogen feedstock discharge and an oxygen discharge; and
a second injection well, connected to the second carbon dioxide discharge, and is configured to pump the second carbon dioxide discharge into the non depleted reservoir for Enhanced Oil Recovery (EOR).

4. The sequestering system of claim 3, further comprising: a Carbonator, configured to receive lime solely from the lime discharge, to remove the carbon dioxide from the fixed emission source.

5. The sequestering system of claim 4, wherein the Carbonator further comprises: a reaction chamber, configured to receive the lime, that enters the Carbonator through a calcium oxide input shoot.

6. The sequestering system of claim 5, wherein the Carbonator further comprises: a paddle wheel inside the calcium oxide input shoot connected to an electric motor; an acidity sensor attached to the reaction chamber and communicatively coupled to the electric motor; wherein the acidity sensor is adapted to control the calcium oxide released through the calcium oxide input shoot into the reaction chamber.

7. The sequestering system of claim 6, wherein the Carbonator further comprises: a pressurized storage container, connected to the reaction chamber; a tail pipe emission source, connected to the pressurized storage container with an air pump; wherein the emissions are pumped from the fixed emission source into the pressurized storage container and are then released into the reaction chamber.

8. The sequestering system of claim 7, wherein the Carbonator further comprises: a gas recycling tube connected to the reaction chamber and an automatic valve configured to permit and restrict access to the gas recycling tube.

9. The sequestering system of claim 8, wherein the Carbonator further comprises a settlement chamber surrounding the reaction chamber, where a calcium carbonate slurry settles and drains into a calcium carbonate slurry tank.

10. The sequestering system of claim 9, further comprising a water pipe attached to the calcium carbonate slurry tank and configured to direct water through the calcium carbonate slurry tank driving the calcium carbonate slurry into a calcium carbonate slurry output pipe.

11. The sequestering system of claim 10, further comprising a water holding tank connected to the water pipe; the water holding tank is further connected to the settlement chamber with a water discharge tube connected to the reaction chamber by a water intake tube; wherein a flow of water in and out of the water holding tank affects a level of water in the reaction chamber.

12. The sequestering system of claim 11, further comprising a water input attached to the water holding tank and a water drain attached to the water holding tank.

13. The sequestering system of claim 1 wherein the fixed emission source is a power generating station.

14. The sequestering system of claim 13 further comprising at least one high voltage direct current transmission line connected to the power generating station.

15. The sequestering system of claim 14 wherein the void is a depleted reservoir of one of the set consisting of a Permian basin and an Anadarko basins; wherein the at least one high voltage direct current transmission line is located in one of the set consisting of a right of way of a Texas Eastern natural gas pipeline and a Tennessee natural gas pipelines; wherein the at least one high voltage direct current transmission line is further located in one of the set consisting of a Transco natural gas pipeline and a Colonial pipeline.

16. The sequestering system of claim 15 further comprising at least one rectifier/inverter thyristor gate station, connected to the at least one high voltage direct current transmission line wherein the at least one rectifier/inverter thyristor gate station is configured to balance frequency and voltage of electricity over various power pools.

17. The sequestering system of claim 16 wherein the power generating station is a coal fired power generation station.

18. The sequestering system of claim 17 wherein the coal fired power generation station receives coal from Tulsa at a terminus of a navigable waterway system.

19. A carbonator, configured to combine lime and carbon dioxide to produce calcium carbonate; the carbonator comprising:
a reaction chamber, configured to receive the lime through a lime input shoot.

20. The carbonator of claim 19, further comprising: a paddle wheel inside the lime input shoot connected to an electric motor; an acidity sensor attached to the reaction chamber and communicatively coupled to the electric motor; wherein the acidity sensor is adapted to control the lime released through the lime input shoot into the reaction chamber.

21. The carbonator of claim 20, further comprising: a pressurized storage container, connected to the reaction chamber; a tail pipe emission source, connected to the pressurized storage container with an air pump; wherein emissions are pumped from the tail pipe emission source into the pressurized storage container and are then released into the reaction chamber.

22. The carbonator of claim 21, further comprising: a gas recycling tube connected to the reaction chamber and an automatic valve configured to permit and restrict access to the gas recycling tube.

23. The carbonator of claim 22, further comprising: a settlement chamber surrounding the reaction chamber, where a calcium carbonate slurry settles and drains into a calcium carbonate slurry tank.

24. The carbonator of claim 23, further comprising: a water pipe attached to the calcium carbonate slurry tank and configured to direct water through the calcium carbonate slurry tank driving the calcium carbonate slurry into a calcium carbonate slurry output pipe.

25. The carbonator of claim 24 further comprising: a water holding tank connected to the water pipe; the water holding tank is further connected to the settlement chamber with a water discharge tube and the reaction chamber with a water intake tube; wherein a flow of water in and out of the water holding tank affects a level of water in the reaction chamber.
